(19) United States
(12) Patent Application Publication
(10) Pub. No.: US 2005/0279094 A1
(43) Pub. Date: Dec. 22, 2005

(54) Almost-perpetual ecology system

(76) Inventor: Kazutora Yoshino, Eden Prairie, MN (US)

Correspondence Address: KAZUTORA YOSHINO, 7227 Divinity Ln., Eden Prairie, MN, 55346, US

(21) Appl. No.: 11/138,781

(22) Filed: May 27, 2005

Related U.S. Application Data
(63) Continuation-in-part of application No. 10/653,553, filed on Sep. 2, 2003.

(51) Int. Cl. F03G 6/00

(52) U.S. Cl. 60/641.8

(57) ABSTRACT

Ecosystem that is highly efficient and environmental is shown. Turbo Hydrogen engine with controlled combustion using the recycling of un-combusted gases such as hydrogen and oxygen can be embedded to this ecosystem. Solar energy and wind energy can be used as external energy source. The energy of motion of a vehicle is charged back to usable energy when it reduces the motion.

### CROSS REFERENCE TO RELATED APPLICATION

This is a continuous-iport application of U.S. application Ser. No. 10/653,553, and/or Doc. Number KYU001E001 (yoshino time machine).

### FEDERALLY SPONSORED RESEARCH

Not Applicable

### SEQUENCE LISTING OR PROGRAM

### BACKGROUND OF THE INVENTION

1. Field of the Invention

The invention is directed to a new ecology system that focus on high efficiency, especially to make hydrogen system to be practical.

Hydrogen and oxygen energy release can provide excellent energy efficiency and can produce combustion gases having only emission of water. However, when used as the primary fuel, it is not necessary to be higher efficiency than conventional systems like using gasoline.

2. Description of the Prior Art

Quigley, Jr. (U.S. Pat. No.3,471,274) discloses a hydrogen combustion engine that uses exhaust pump to remove exhaust gases.

Stowe (U.S. Pat. No. 5,231,954) discloses a hydrogen and oxygen fuel cell for thermal efficiency and for reduction of emissions.

Ovshinsky et al. (U.S. Pat. No. 6,305,442) disclose a hydrogen-based ecosystem. Yet this does not give concrete details to be practical system with high efficiency for market-ready system.

Swain et al. (U.S. Pat. No. 5,603,290) discloses a hydrogen engine with no-abnormal combustion.

The problem remains, however, that overall efficiency of hydrogen system is not maximized to be practical yet

### SUMMARY OF THE INVENTION

This invention use Feed-forward, Feed-backward control Optimal-control, PID control, Neural control, Auto-control. Together with stem feed forward, feed back, feed combination, feed network delta method is added, alternatively for optimal control. This invention enable user to have almost perpetual ecology system because it is super efficiently effective system. So users can ride with vehicle without adding almost any fuel in with this invention.

The system of invention holds the entropy and energy almost the same or preferably increasing as time in the system. It is consist of heat insulator (and conductor pipe) with superconductor motor with ecology system comprising group comprising fuel cell, recyclable fuel, fuel cell, battery, tank for fuel, propeller wind, and/or solar system.

The system of invention has heat insulating and concealing walls that confine the characters such as particles, chemicals, energy and entropy to be kept well in said concealing walls. The characters are entrapped in confiner so that energy or entropy cannot escape easily. Energy and/or entropy from out side may be added or subtracted properly. Yet, it doesn't have to have a lot of amount of characters that go in and out. The most of the characters such as energy and/or entropy is controlled so that the entire system is statically and/or dynamically in balance. In other words, without adding too much amount of characters such as energy and gas, the system keeps running almost-perpetually.

The simple case of this is almost perpetual vehicle. It charges energy charger by the power generated by fan(s) which is assembled toward motional direction. The charged energy is used for motion of vehicle. When the vehicle is reducing speed or stopping, the extra-energy goes back to energy charger which is used when the vehicle is increasing speed.

Similarly entropy charger may be used for entropy of system.

Meal+hydrogen combination is used for the character exchange of the system.

Roughly speaking,

$$F ∝ Δ A \frac{{n}^{2}}{V} R \frac{Δ H}{Δ t} .$$

A is area, n is number of reactant, V is reaction volume, R is const/variable, H is heat/energy, t is time.

Also, ion cooling system is shown. Having extra potential, it cools down more efficient and effectively in compact size.

$${P}_{i} + \frac{1}{2} {ρ}_{i} {v}_{i}^{2} + {ρ}_{i} {y}_{i} g + {k}_{az} {η}_{i} {ϕ}_{i} = const . / function .$$

P is pressure, ρ is density, v is velocity, y is height, g is gravity, η is charge (/magnetic moment, spins), φ is potential. The value of k_{az} is the value to determine the temperature controlling system. Multiple cooling may be done, alternatively.

With some calculations of quantum physics,

$$T ↓ ∝ \frac{P ↓ A ↓ v ↓ h ↓}{n ↑ R ↑ Δ E ↑}$$

T is temperature, P is pressure, A is area, v is velocity, h is plank constant/variable, n is number of particles, R is const./function, E is energy. From the equation, when temperature goes down very bottom, there are some chances that “Energy Nova” is going to happen.

Simple potential maker may be electric potential (voltage), and/or magnetic potential.

Super computer is used to calculate the information of future.

The profits and risks in the future is read based on the calculation of super computers.

As for vehicle, the optimal path is shown to user and/or vehicle by letting user and/or vehicle know the super-computer calculated future information, hopefully.

“and/or” is often shown as AOR, here.

### OBJECTS AND ADVANTAGES OF THE INVENTION

This almost-perpetual ecology system runs for long time. It also runs inexpensively. And the system correspondence (& time) to what user likes the system to do is excellent And for vehicle, the optimal path is shown to user and/or vehicle.

### BRIEF DESCRIPTION OF THE DRAWINGS

FIG. 1-1 shows the diagram of specimen change of characters. Having initial conditions and formula (rules), phenomenon, the rest of values are deterministic.

FIG. 1-2 shows the diagram of simulation possibility/probability.

FIG. 2-1 shows the diagram of box-type yoshino time machine.

FIG. 2-2 shows the diagram of box-type yoshino time machine. It uses information flow. FIG. 2-3 shows the diagram of box type yoshino time machine. It uses rotational system FIG. 24 shows the diagram of box type yoshino time machine. It uses multi-dimensionally rotational system.

FIG. 2-1 and/or FIG. 2-2. C60, C70, diamond, are used as alternative.

FIG. 2-5 shows the diagram of very simple version of LR yoshino time machine system.

FIG. 2-6 shows the diagram of brain interaction of information of future/present/past.

FIG. 3-1-1-1 shows the diagram of photon cell (solar cell).

FIG. 3-1-1-2 shows the diagram of photon cell (elementary particle cell). It separates the long wave and short wave of light by lens/prism/modulator.

FIG. 3-1-2 shows the diagram of metal and hydrogen fuel cell.

FIG. 3-1-3-1 shows the diagram of ecology system.

FIG. 3-1-3-2 shows the diagram of super conductor ecology system.

FIG. 3-1-4 shows the diagram of the alternative system for the combination system. FIG. 3-1-5 shows the diagram of alternative cycling system.

FIG. 3-2-1-1 shows the diagram of ion/potential cooling system.

FIG. 3-2-1-2 shows the diagram of particle(s) cooling system.

FIG. 3-2-2-1 shows the diagram of insulators.

FIG. 3-2-2-2 shows the diagram of container with insulator.

FIG. 3-2-3 shows the diagram of (superconductor) coils/magnets put with relay style. FIG. 3-2-4 shows the diagram of superconductor coils.

FIG. 3-2-5 shows the diagram of superconductor motor and/or generator with cooling material.

FIG. 4-1-1 shows the diagram of circular motion.

FIG. 4-1-2 shows the diagram of going back and force motion.

FIG. 4-2 shows the diagram of almost perpetual ecological vehicle.

FIG. 4-3 shows the diagram of simple superconductor energy conserving system.

FIG. 4-4 shows the diagram of almost perpetual vehicle.

FIG. 4-5 shows the diagram of alternative energy conserving system.

FIG. 4-6 shows the diagram of alterative energy conserving system. Motion maker or motor may be put in one.

FIG. 4-7 shows the diagram of alternative energy conserving system.

FIG. 4-8 shows the diagram of alternative energy conserving system. Superconductor coil(s) may be used for saving energy as energy charger or battery.

FIG. 4-9 shows the diagram of feedback system of energy conserving system. Efficiency may be increasing by feeding back and feed forward system.

FIG. 5-1 shows the diagram of almost perpetual car.

FIG. 6-1 shows the diagram of precursor of body of vehicle.

FIG. 6-2 shows the diagram of alternative precursor of body of vehicle.

FIG. 6-3 shows the diagram of rough showing of vehicle/car.

FIG. 7-1-1 shows the diagram of ecology system of home.

FIG. 7-1-2 shows the diagram of ecology system of home/unit.

FIG. 7-2-1 shows the diagram of line/curve motion of vehicle/motion unit.

FIG. 7-2-2 shows the diagram of line/circle/circular/rotational motion of vehicle/motion unit.

FIG. 7-3 shows the diagram of motion controlling unit(s) between the line/lines. It may be made of coils/magnet such as superconductor magnet.

FIG. 7-4 shows the example diagram of potentials around motion controlling units. FIG. 7-5-1 shows the diagram of vehicle/train/superconductor car/linear car/motion maker.

FIG. 7-5-2 shows the diagram of side view of train means such as train superconductor car/linear motor car.

FIG. 8-2 shows the diagram of space ship/super ship/ship/submarine.

FIG. 8-3-1 shows the diagram of air plain/submarine.

FIG. 8-3-2 shows the diagram of ram engine/jet engine.

FIG. 8-4 shows the diagram of space shuttle/space-rancher/traveler.

FIG. 8-5 shows the diagram of engine of space shuttle/vehicle.

FIG. 8-6 shows the diagram of engine. The mixing of hydrogen and oxygen is shown as preferred choice.

FIG. 8-7 shows the diagram of engine. The mixed stage or processing stage may be shown.

FIG. 8-8-1 shows the diagram of engine. Vertical motion is shown. Body weight shift may be used for controlling of direction, alternatively.

FIG. 8-8-2 shows the diagram of engine. Vertical motion may be controlled by gas emission power of Left, Right, or plurality of units. They may be interconnected to balance fuels, alternatively.

FIG. 8-9 shows the diagram of ram engine. Compressed oxygen is mixed up with hydrogen. It fires for force.

FIG. 8-10-1 shows the diagram of yoshino floater side view. It floats and runs.

FIG. 8-10-2 shows the diagram of floater bottom view.

FIG. 8-10-3 shows the diagram of yoshino floater perspective view. Head chooses the direction of motion. Head may rotate. It may have artificial intelligence for control. User may ride on it.

FIG. 8-10-4 shows the diagram of basic structure of floater.

FIG. 8-10-5-1 shows the diagram of floater leg. It may have ram engine in leg. Leg may be used for cooling system of superconductor magnet or motor.

FIG. 8-10-5-1 shows the diagram of floater leg. It may have ram engine/jet engine in leg. Fans are added, alternatively. Leg may be used for cooling system of superconductor magnet or motor.

FIG. 8-11-1 shows the diagram of space traveler. It has plasma engine with directional control. The control unit of magnetic field is added to control the flow of plasma.

FIG. 8-11-2 shows the diagram of plasma engine with directional control. Electric field and/or magnetic field is changed for directional control or for balance.

FIG. 8-11-4 shows the diagram of space ship type QA. It has container/insulator.

FIG. 8-12-1 shows the diagram of basics of Yoshino flying object (Y.F.O.) engine.

FIG. 8-12-2 shows the diagram of Y.F.O. side view.

FIG. 8-12-3 shows the diagram of Y.F.O. This type has fuel box with ducts for air/gas/liquid/solid/plasma flow, with flow channels and its control.

FIG. 8-12-4 shows the diagram of multi-environmental spaceship.

FIG. 9-1-1 shows the diagram of instant travel/fax/copier. Whenever-gate and/or where-door are shown.

FIG. 9-1-2 shows the diagram of instant travel/fax/copier. Multiple whenever-gate and/or where-door are shown.

FIG. from 9-2-1-1 to FIG. 9-2-3-3 show the diagrams of instant travel having control of space-time-informational coordinates.

FIG. 9-2-1-1 shows the diagram of the diagram of element (including object(s)) at space-time-informational coordinate.

FIG. 9-2-1-2 shows the diagram of element with space-time-informational coordinate. It Coordinates are shrinking and/or expanding properly so that traveling element may travel through faster than usual.

FIG. 9-2-2-1 shows the diagram of element with space-time-informational coordinate. It shows coordinates with warm holes.

FIG. 9-2-2-2 shows the diagram of element with space-time-informational coordinate. It shows the rainbow bridge.

FIG. 9-2-2-3 shows the diagram of element with space-time-informational coordinate. It shows cut(s)/hole(s) in coordinates.

FIG. 9-2-3-1 shows the diagram of element with space-time-informational coordinate. It shows cut(s)/hole(s) and fold(s) of coordinates.

FIG. 9-2-3-2 shows the diagram of element with space-time-information coordinate. It shows cut(s)/hole(s), fold(s), and bridge(s) of coordinates.

FIG. 9-2-3-3 shows the diagram of element with space-time-informational coordinate. It shows cut(s) and/or fold(s)

FIG. 10-1 shows the diagram of almost perpetual system. When ecology system motion unit is moving/rotating, and if the delta mass is controlled so that entire mass is virtually the same, entire momentum is conserved. Only the delta m momentum is modified in almost perpetual system. If the delta mass unit/base system has charger to save momentum/energy, it keeps reusing the momentum and energy.

FIG. 10-2 shows the diagram of almost perpetual system. Gravity and/or black hole are used for motion generation and/or control of element(s)/object(s).

### DESCRIPTION OF SPECIFIC EMBODIMENT

These are self-explanatory. Yet, for the help of understanding, the explanation is shown. Most of expressions are made for the simplicity of understanding or showing rather than exact calculation. It shall still have sufficient meaning in such expressions for invention. It may be based on special neural expectation. Some analytical calculation was rather-made for specific case. Other values or graphs are conception-ally assigned/expected for the spirit of invention.

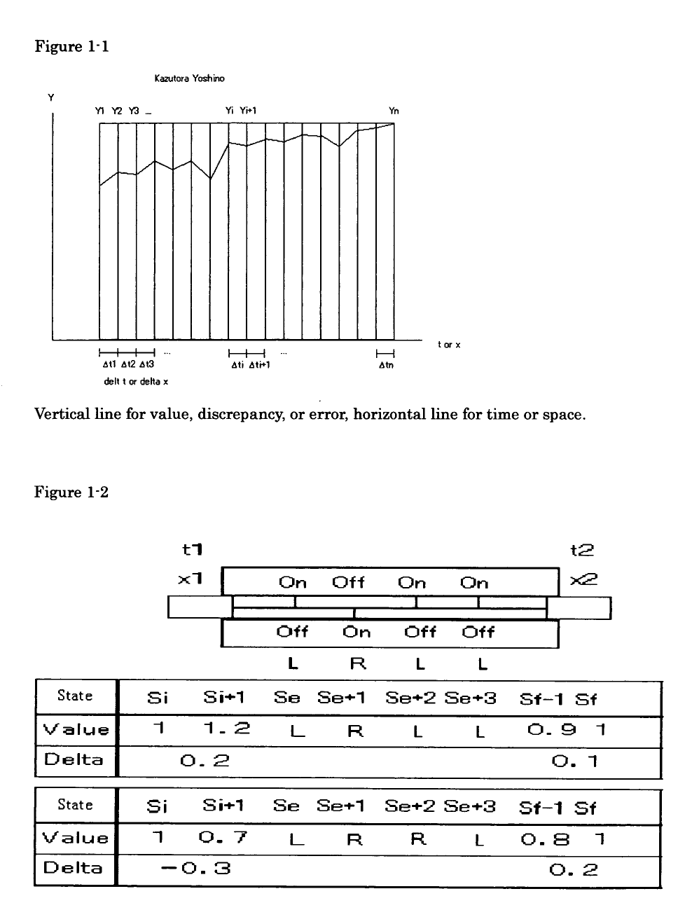

FIG. 1-1 shows the diagram of specimen change of characters. Having initial conditions and formula (rules), phenomenon, the rest of values are deterministic.

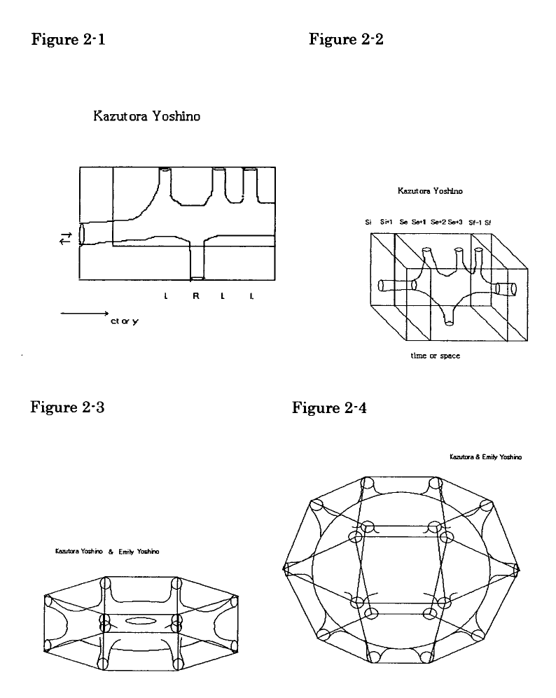

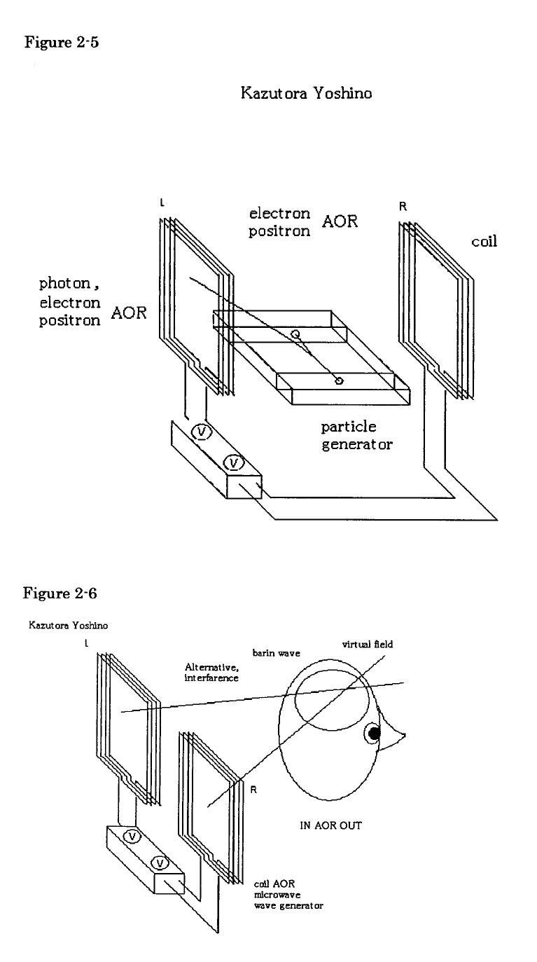

FIG. 1-2 shows the diagram of specimen simulation. By having data base of all combinations of future signals it can know the future when it receive the early information.

FIG. 2-1 shows the diagram of box-type yoshino time machine. It uses information flow such as molecule(s), atom(s), proton(s), neutron(s), electrons\s), positron(s), photon(s), pi-on(s), elementary particle(s) and/or super string(s). Based on the future signal, the initial information has proper characters which show the future information.

FIG. 2-2 shows the diagram of box-type yoshino time machine. It uses information flow such as molecule(s), atom(s), proton(s), neutron(s), electron(s), positron(s), photon(s), pi-on(s), elementary particle(s) and/or super string(s). Based on the enforced future signal, the sequences of initial information have proper characters which show the enforced future information.

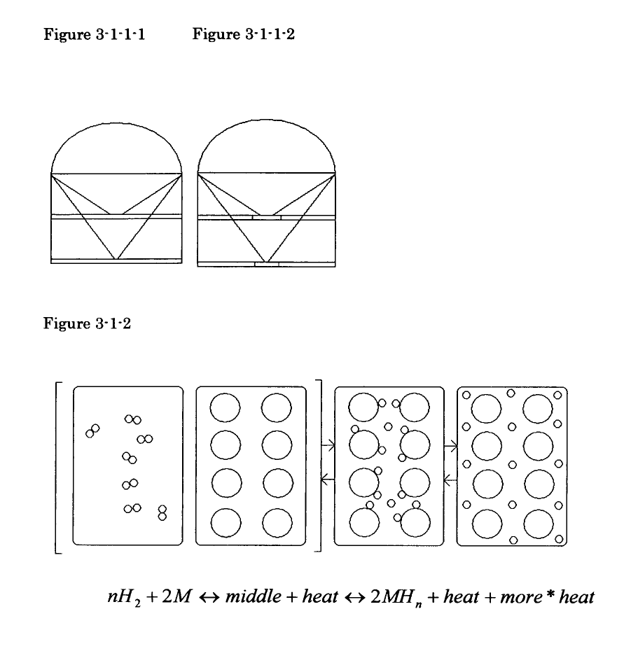

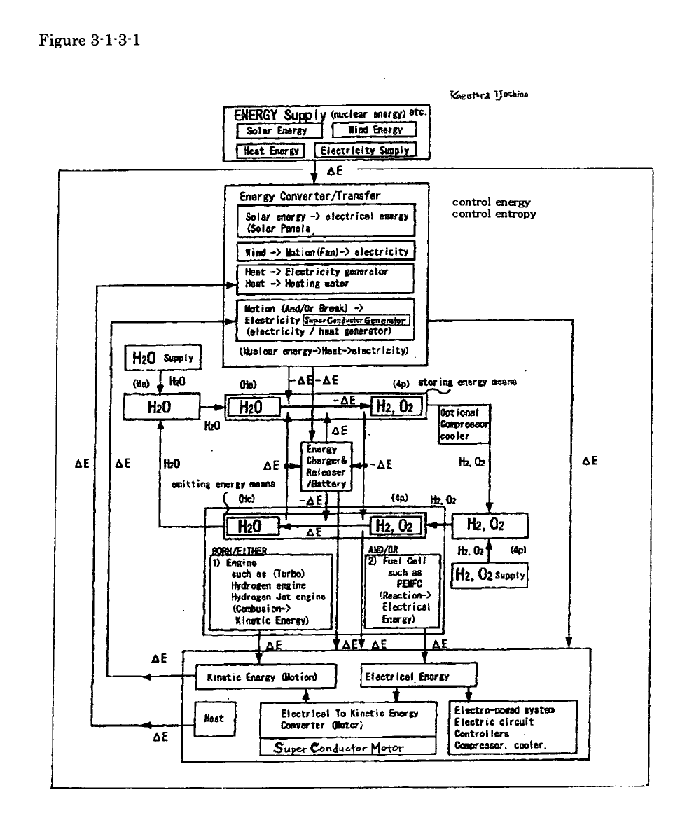

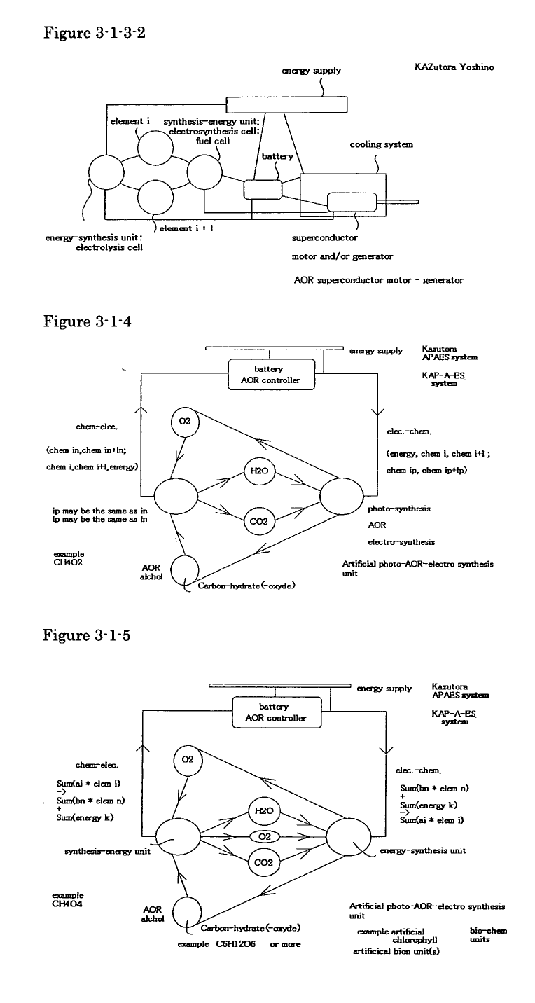

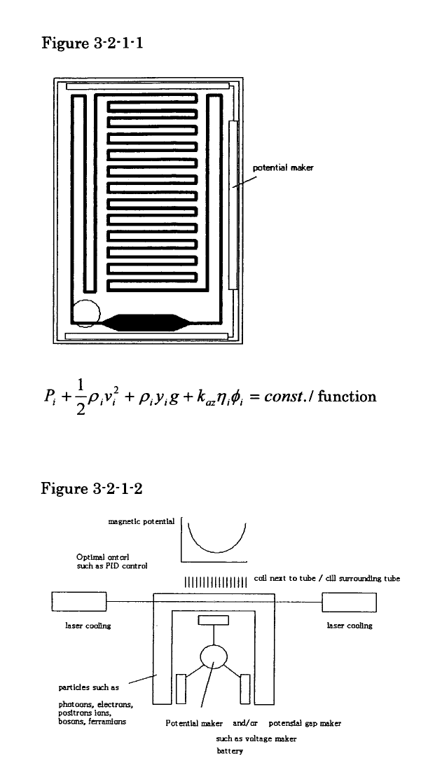

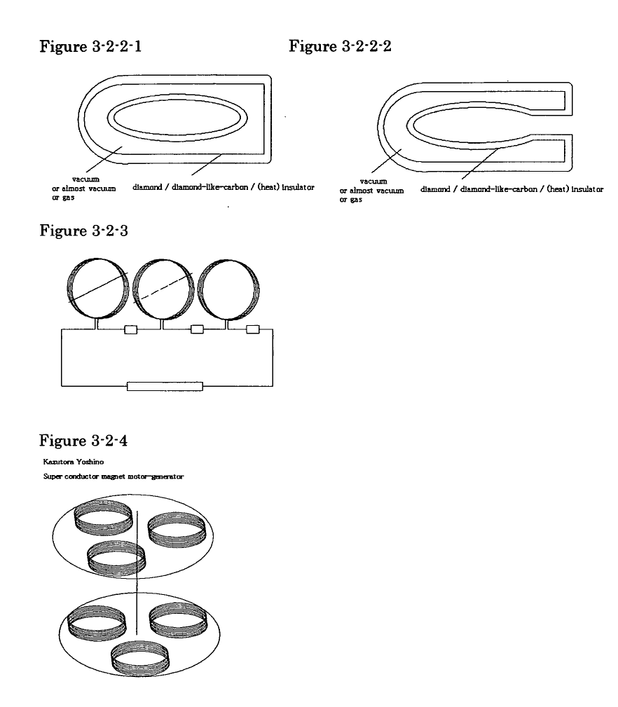

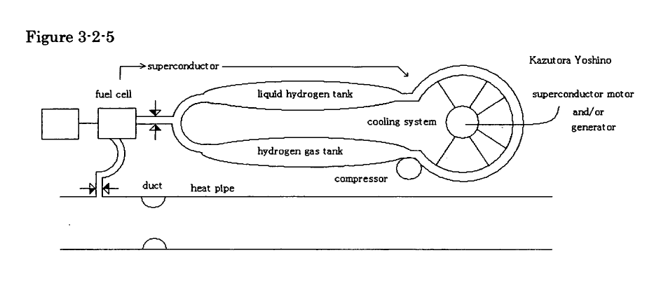

FIG. 2-3 shows the diagram of box type yoshino time machine. It uses rotational system. It may be used for recycling system or feed back system of FIG. 2-1 and/or FIG. 2-2. Benzene ring/benzene ring like/nano tubes are used as example.

FIG. 2-4 shows the diagram of box type yoshino time machine. It uses multi-dimensionally rotational system. It may be used for recycling system or feed back system of FIG. 2-1 and/or FIG. 2-2. C60, C70, diamond, are used as alternative.

FIG. 2-5 shows the diagram of very simple version of LR yoshino time machine system. It reads/supposes the future information based on the behavior of beam characters. Based on how the beam interfere with other elements enforced from Left or Right in the future, it calculated the probability of which side the enforcement may be.

FIG. 2-6 shows the diagram of brain interaction of information of future/present/past. Informational field is created as input field and/or output field to and/or from brain. Future/present/past information may be directly considered for user(s).

FIG. 3-1-1-1 shows the diagram of photon cell (solar cell). It separates the long wave and short wave of light by lens/prism/modulator. Longer wave length may be converted to heat and shorter wave length may be converted to electricity, as alternative. Silicon, from-photon-to-electron converter, from-heat-to-electron converter, and/or photon-heat-electron converter may be used as alterative.

FIG. 3-1-1-2 shows the diagram of photon cell (elementary particle cell). It separates the long wave and short wave of light by lens/prism/modulator. Base receivers may be separated to sections.

FIG. 3-1-2 shows the diagram of metal and hydrogen fuel cell. Energy and entropy is exchanged in the unit system.

FIG. 3-1-3-1 shows the diagram of ecology system. It has confiner such as heat insulator as part of system to control the energy and entropy.

FIG. 3-1-3-2 shows the diagram of super conductor ecology system. It receives energy. It may charge/store the energy to battery, alternatively. Energy is used for bringing element energy higher than at energy-synthesis unit(s). If (cold) water is used, energy-synthesis unit separate atoms to (cold) hydrogen and (cold) oxygen. These are combined at synthesis-energy unit to release energy. Super conductor magnet is used for motor and/or generator. Superconductor magnet system may be used for both motor and generator. It works by Lents law and Fleming hand law.

Elements may be any elements that emit or absorb energy. The example choice is the group comprising hydrogen, oxygen, liquid hydrogen and/or liquid oxygen.

FIG. 3-1-4 shows the diagram of the alternative system for the combination system. Carbon hydrates are used for the recycling of the energy/entropy system. Alcohol may be a choice for this kind.

FIG. 3-1-5 shows the diagram of alternative cycling system. Artificially energy synthesis is done. Glucose/organic material/matter may be used to save up energy.

FIG. 3-2-1-1 shows the diagram of ion/potential cooling system, cooling system such as ion cooling system/plasma cooling system/gas-liquid cooling system, liquid-liquid cooling system, gas-gas cooling system. Alternative potential makes ion (and/or magnetic) gas cool down better.

The rough law of cooling with potential is shown

$${P}_{i} + \frac{1}{2} {ρ}_{i} {v}_{i}^{2} + {ρ}_{i} {y}_{i} g + {k}_{az} {η}_{i} {ϕ}_{i} = const . / function / variable .$$

Based on the system, the right side of the equation may be dramatically changed. Yet, for the simple case, the electrical charges with higher electrical potential gap such as voltage difference make more acceleration in cooling in the system. Multiple cooling may be used. In other words, cooling system is in cooling system to accelerate the cooling.

FIG. 3-2-1-2 shows the diagram of particle cooling system.

$$T ↓ ∝ \frac{P ↓ A ↓ v ↓ h ↓}{n ↑ R ↑ Δ E ↑} .$$

T is temperature, P is pres, A is area, v is velocity, h is plank constant/variable, n is number of particles, R is const./function, E is energy. From the equation, when temperature goes down very bottom, there are some chances that “Energy Nova” is going to happen.

FIG. 3-2-2-1 shows the diagram of insulators. Vacuum, gas, liquid, solid may be filled in gap of container. It shows the vacuum as example. Diamond/Diamond-like-carbon/silver/aluminum/metal/organic material/inorganic material may be used for coating. Basically, elastic bouncing (of material(s)) on boundary may be created.

FIG. 3-2-2-2 shows the diagram of container with insulator.

FIG. 3-2-3 shows the diagram of(superconductor) coils/magnets are put with relay style. If superconductor magnets are put next to each other, magnetic fluxes are jumping around. This is partly because of the Lents law and London's law. Magnetic insisting flux effect may be in consideration.

FIG. 3-2-4 shows the diagram of superconductor coils. When multiple superconductor coils are put with proper voltage or zero voltage, it moves as motor. Reversely, when superconductor coils are put in magnetic field and have magnetic flux difference in time, it generates voltage.

$$V = N \frac{ⅆ ϕ}{ⅆ t} .$$

As shown in relay method of superconductor coils, if fluxes are jumping around in superconductor coils/magnets, and plurality of those coils are put together, it keeps moving almost perpetually, supposing there is virtually no friction or other factors that slow down the system.

FIG. 3-2-5 shows the diagram of superconductor motor and/or generator with cooling material is shown. The cooling material may be used for energy generation in fuel cell. Here, gas hydrogen, liquid hydrogen and compressing system is shown. By external-cooling system may be added, alternatively.

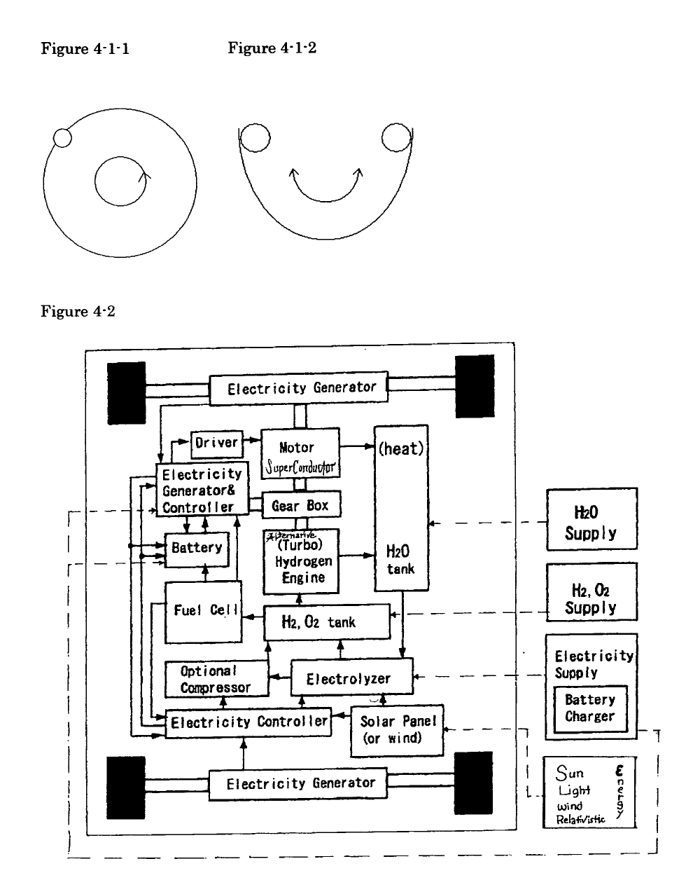

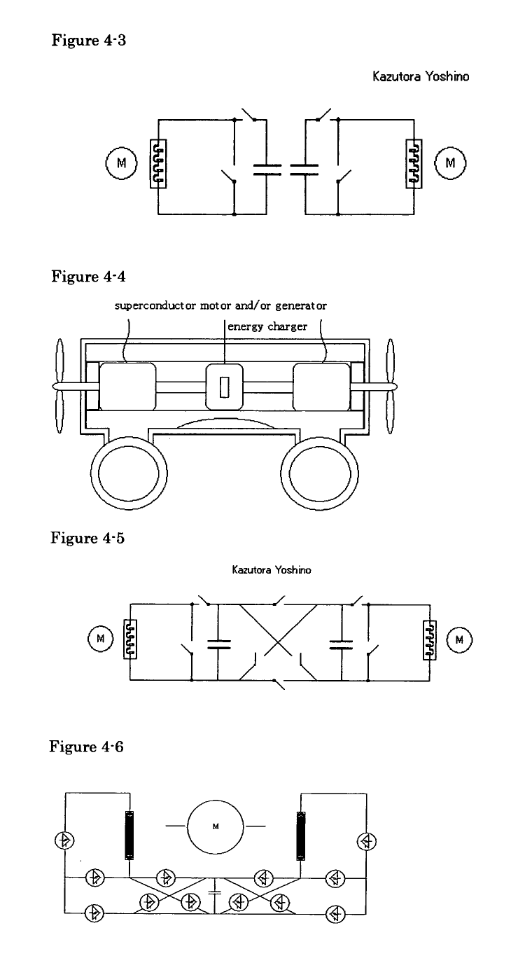

FIG. 4-1-1 shows the diagram of circular motion. With proper potential and kinetic motion, energy is conserved if friction is small. If harmonic motion with small friction, it keeps moving long time. Electrons may be coupled in superconductor. And they are rotating with almost constant energy. Superconductor keeps current running in circuit or coils. If superconductor forms the coils, it is almost perpetually magnetic if environment is proper.

FIG. 4-1-2 shows the diagram of going back and force motion. With having conservation of energy, it keeps moving. In other words, without having much energy loss, it keeps moving almost perpetually. This concept is used for the motional almost-perpetual system. Kinetic energy is saved to energy charger when motion is reduced. And energy-charger releases the energy to make motion. The heat may be converted to electricity and/or charged to energy-charger. System controller controls the temperature of system properly. Heat insulator may enable not letting heat escape from system, alternatively.

FIG. 4-2 shows the diagram of almost perpetual ecological vehicle. It holds the whole energy and entropy almost the same. Energy-charger and entropy insulator such as heat insulator are surrounding the system. Superconductor motor and/or superconductor generator is put for the efficiency and practical (horse) power. Solar, wind energy may be used for the energy addition/control.

FIG. 4-3 shows the diagram of simple superconductor energy conserving system. When motion is on, superconductor coil is used, and the energy is charged in coil. When it reduces the motion, the extra energy goes to battery/condenser. Proper switching may be done.

FIG. 4-4 shows the diagram of almost perpetual vehicle. Superconductor motor-generators are used. When one side is used as superconductor motor, and when it reduces energy, other side is used as superconductor generator to save the energy gap to energy-charger.

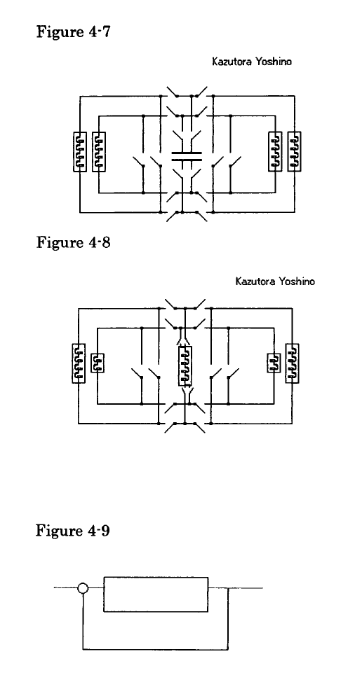

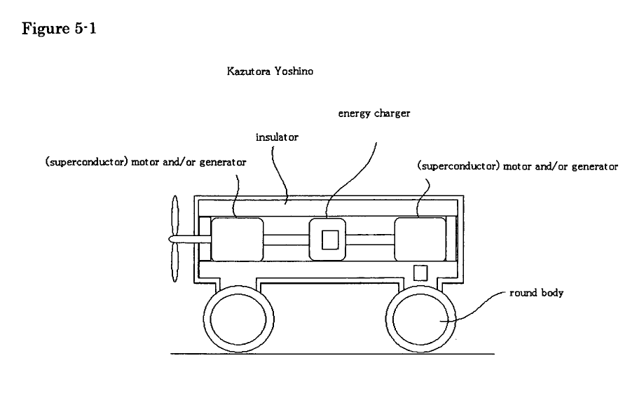

FIG. 4-5 shows the diagram of alternative energy conserving system. Switching may be done by switch means such as switch, switching transistor, IC, TTL, CMOS. By timing the switching, the energy goes to wherever proper. And energy and entropy is almost conserved.

FIG. 4-6 shows the diagram of alternative energy conserving system. Motion maker or motor may be put in one.

FIG. 4-7 shows the diagram of alterative energy conserving system.

FIG. 4-8 shows the diagram of alternative energy conserving system. Superconductor coil(s) may be used for saving energy as energy charger or battery. Energy chargers may be combined to make the system be efficient

FIG. 4-9 shows the diagram of feedback system of energy conserving system. Efficiency may be increasing by feeding back system for discrepancy may be corrected by PID or proper/optical control. μ(-box) may be considered From-IN-feed forward-Convert-to-OUT and From-out-feedback-convert-to-in operation is used for controlling. Delta method may be used. Plurality of feed-forward and feed-back system may be used as alternative.

FIG. 5-1 shows the diagram of almost perpetual car. Superconductor magnet system such as superconductor motor, superconductor generator and superconductor motor-generator is used. When it runs, it uses the superconductor motor (and/or generator). And it may save energy of friction to energy charger by rotating fan/generator. And when it reduces speed or stops, the motion energy is saved to energy charger by superconductor generator (and/or motor). It may float using superconductor super lifter. It may be consist of superconductor material/shell on magnet.

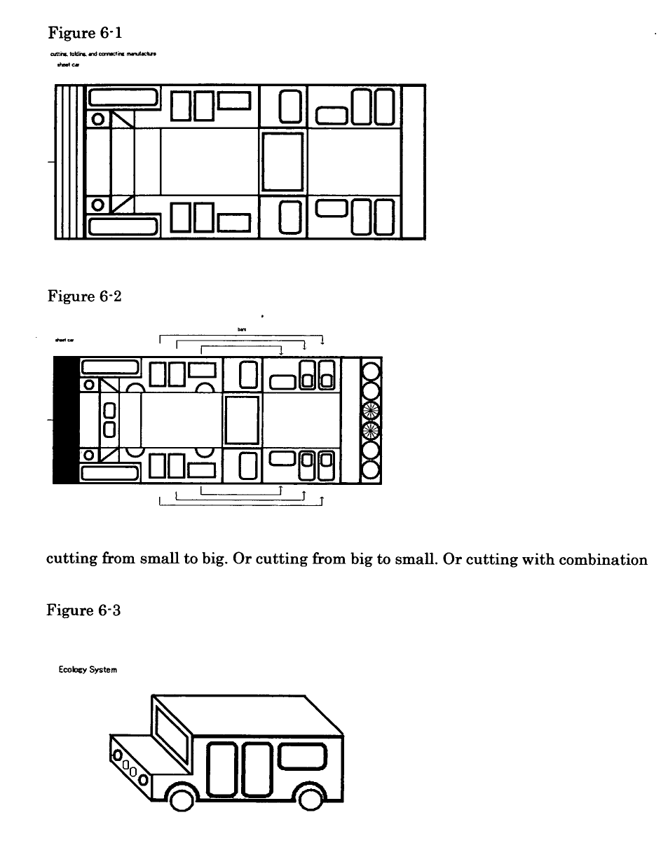

FIG. 6-1 shows the diagram of precursor of body of vehicle. By cutting, folding, adding, subtracting, multiplying, dividing, milling, attaching, polishing, painting, putting components, assembling, wiping, and cleaning, vehicle(s) is/are built.

FIG. 6-2 shows the diagram of alternative precursor of body of vehicle.

FIG. 6-3 shows the diagram of rough showing of vehicle/car.

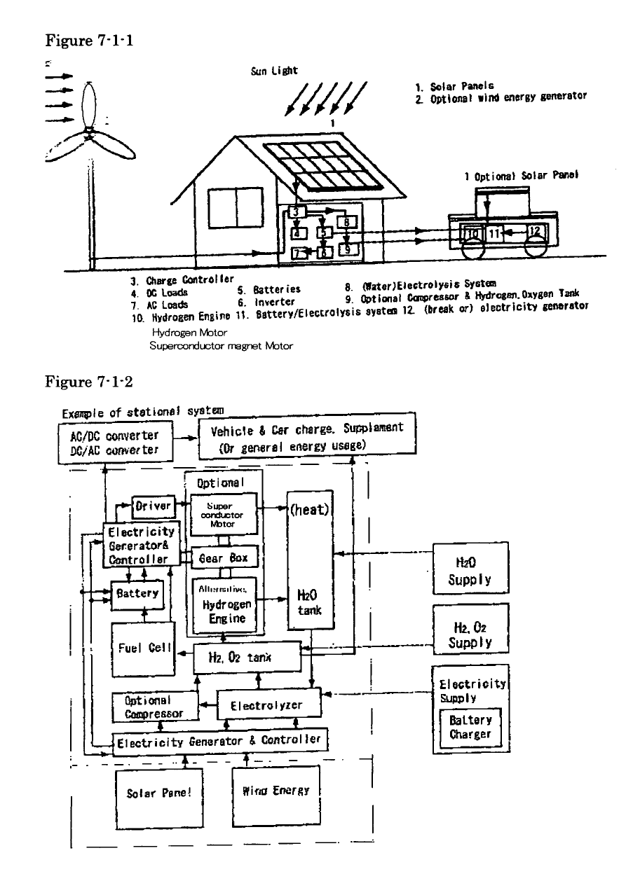

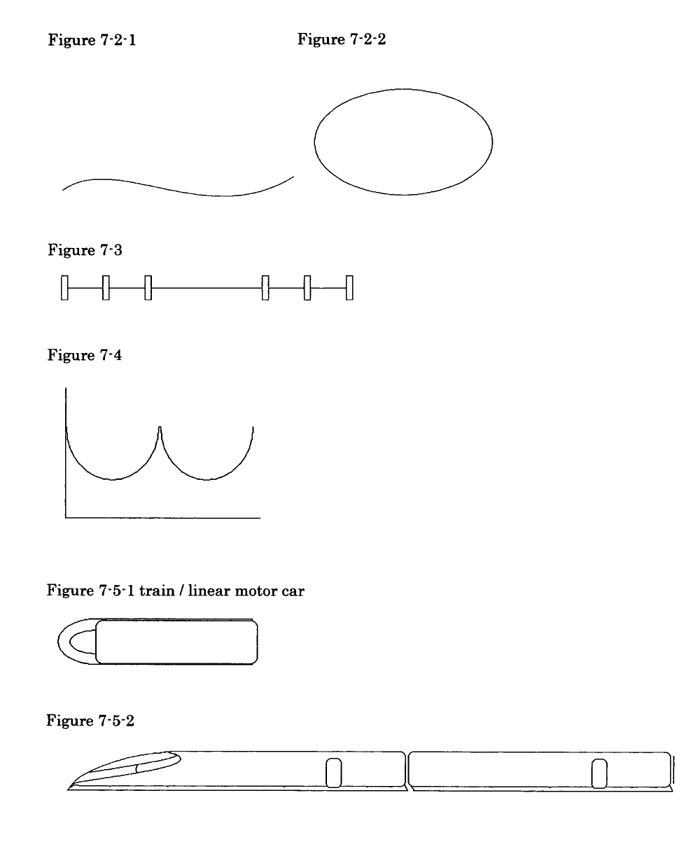

FIG. 7-1-1 shows the diagram of ecology system of home. Insulators are clearly shown in the figure. It controls the energy and entropy efficiently. Superconductor motor and/or generator are used. It may have cooling system together with it. External energy is stored efficiently and used at the timing of convenience for user(s). Energy exchanging system may be put, alternatively. Houses and/or units are connected or communicated with energy exchanging system, alternatively.

FIG. 7-1-2 shows the diagram of ecology system of home/unit. Insulators are clearly shown in the figure. It controls the energy and entropy efficiently. Superconductor motor and/or generator are used. It may have cooling system together with it. External energy is stored efficiently and used at the timing of convenience for user(s). Energy exchanging system may be put, alternatively. Houses and/or units are connected or communicated with energy exchanging system, alternatively. Hydrogen engine is alternatively put Superconductor motor power/motion generation may be put alternatively. Only fuel cell may be used for power generation, alternatively. Battery is put alternatively. Energy from energy exchanger (energy exchanging system/unit) may be supplied, alternatively. It may supply energy to energy exchanger, alternatively.

FIG. 7-2-1 shows the diagram of line/curve motion of vehicle/motion unit

FIG. 7-2-2 shows the diagram of line/circle/circular/rotational motion of vehicle/motion unit.

FIG. 7-3 shows the diagram of motion controlling unit(s) between the line/lines. It may be made of coils/magnet such as superconductor magnet. It may be used for accelerating/de-accelerating vehicle/motion unit.

FIG. 7-4 shows the example diagram of potentials around motion controlling units. Vehicle/motion unit may be going from high potential to low potential gaining speed and/or kinetic energy, it leads the motion to high potential by saving/storing the kinetic energy. It keeps the moving almost perpetually using such conservation of energy or almost-conservation of energy. System of superconductor magnet(s) and interaction may be used as alternative.

FIG. 7-5-1 shows the diagram of vehicle/train/superconductor car/linear car/motion maker. Superconductor motor and/or generator are used, alternatively. Superconductor motor and/or generator may be linear and/or rotational, alternatively. Train may lift itself up to the wait with which the transactional motion may be enough, alternatively. Alternatively, vertical resistance force may be from zero to max force/weight and may be choose properly based on system including curves and timings. Air lifting, field lifting and/or superconductor lifting may be used. Alternatively, Air pushing, field pushing and/or superconductor pushing may be used to gain of transactional force. These lifting and pushing may be controlled based on the system including curves and timings.

FIG. 7-5-2 shows the diagram of side view of train means such as train/superconductor car/linear motor car. Air cooing system may be added for cooling system of super conductor cooling system, alternatively. The ion cooling system may be added to vehicle/motion units or train means, alternatively. It may be the combinations, alternatively. It may fly alternatively. Jet/ram engine, shape or curve duct may be used, alternatively.

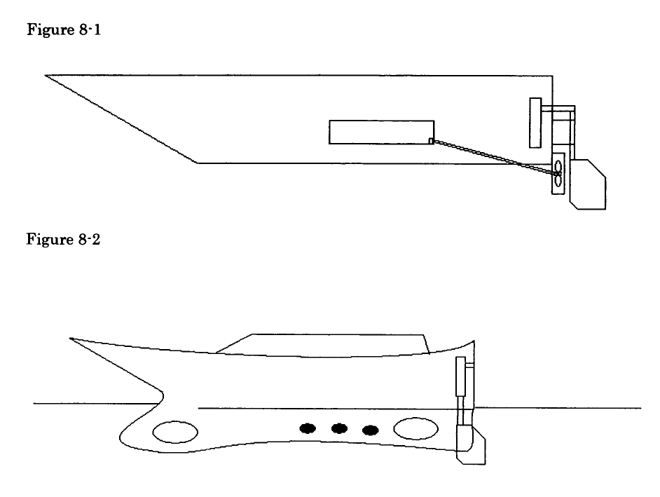

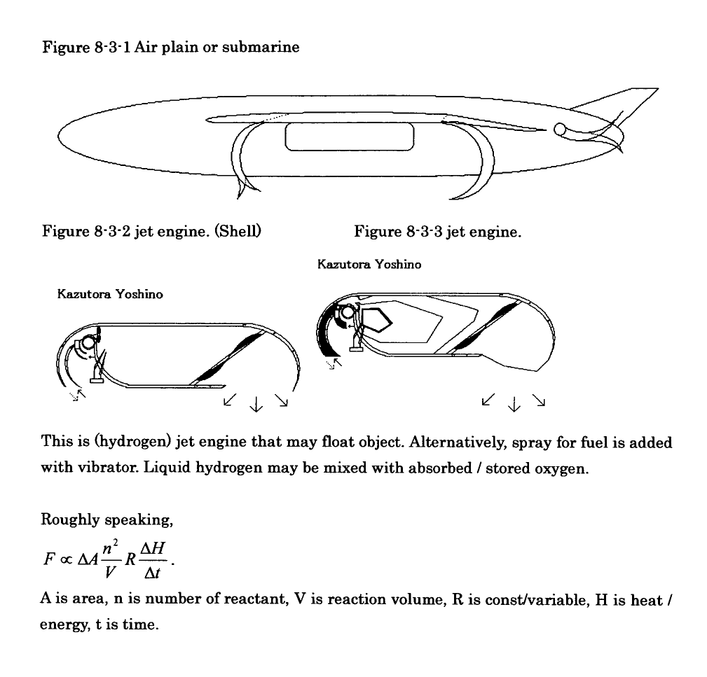

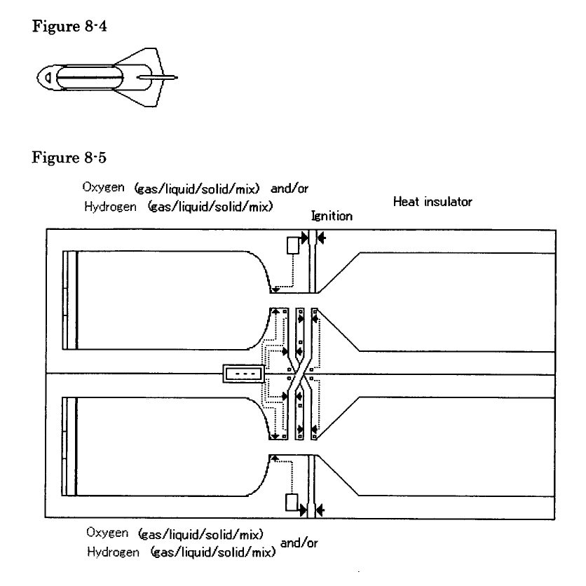

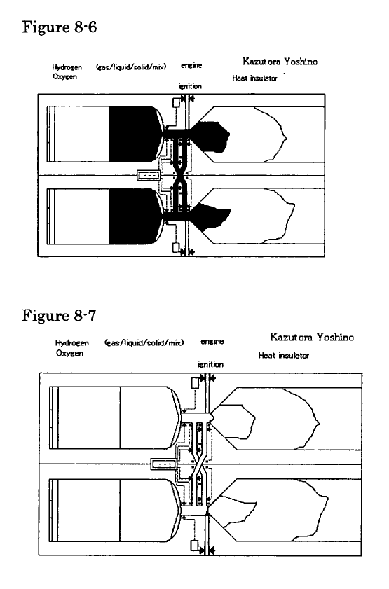

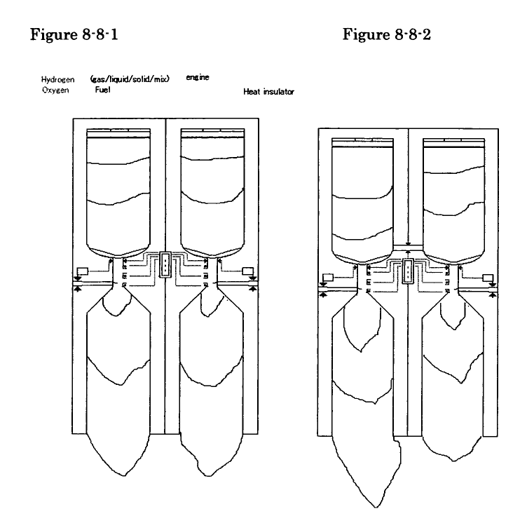

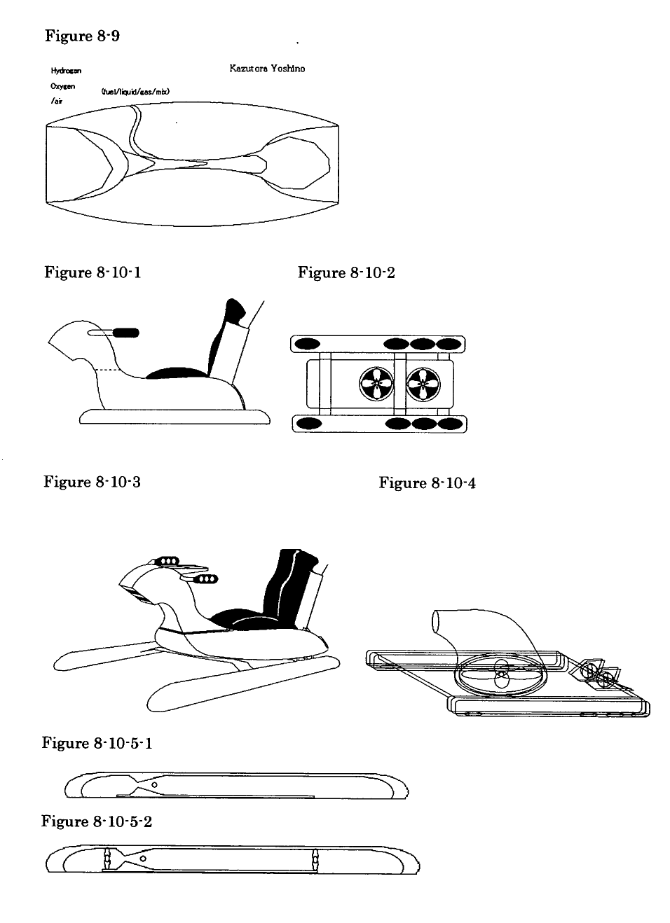

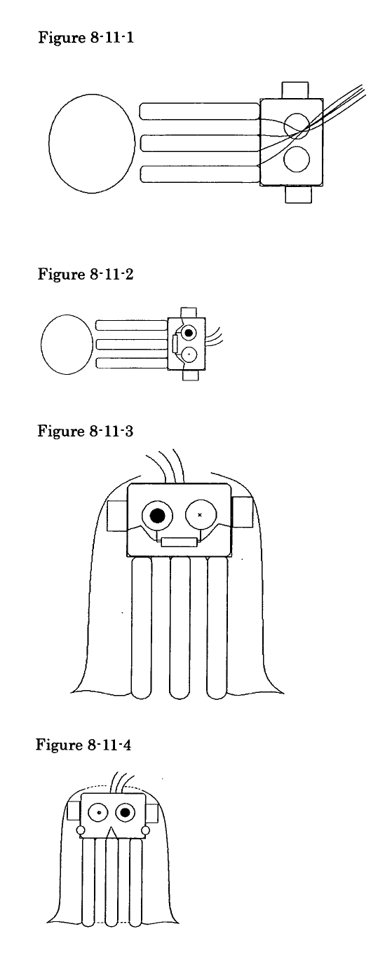

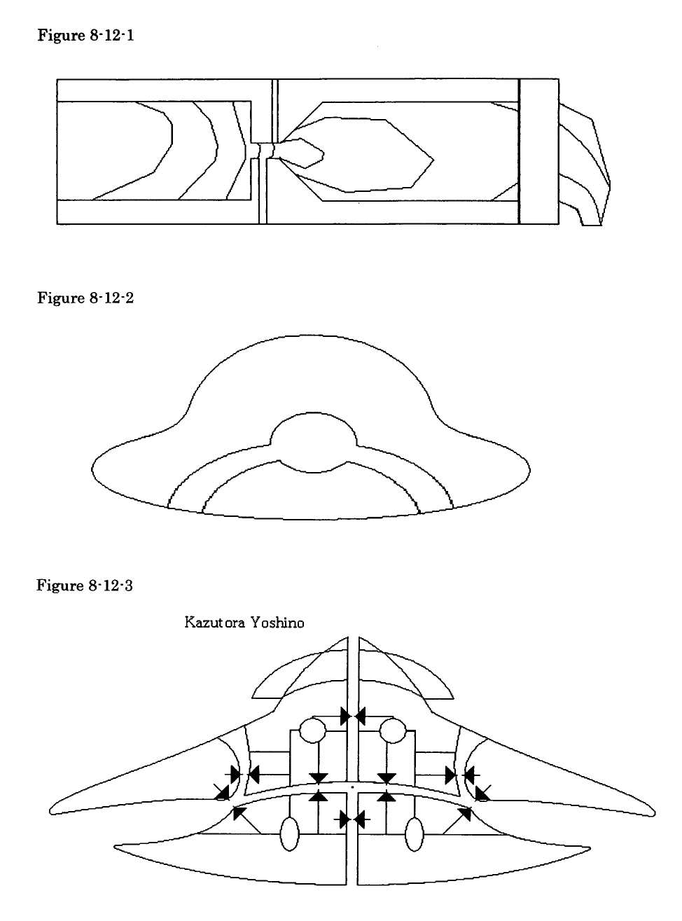

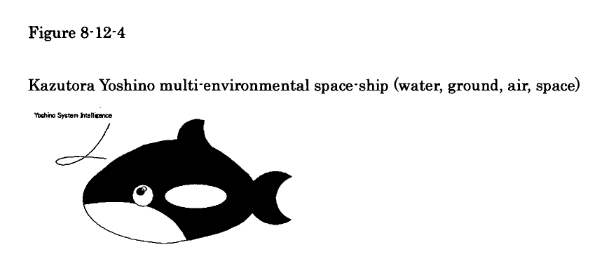

FIG. 8-1 shows the diagram of ship. It has superconductor magnet. Superconductor motor and/or generator weight is proper for ship weight The deck or surface may be used to put solar system and wind energy generator, alternatively. It has ecology system alternatively. It may float if necessary, alternatively.

FIG. 8-2 shows the diagram of space ship/super ship/ship/submarine. It has jet engine/plasma jet engine/ion jet engine/ram engine. It may be rather silent with design.

FIG. 8-3-1 shows the diagram of air plain/submarine. It has wings to control the vertical and horizontal motion/directions. The morphing of wing shapes enables for vehicle to move more freely, alternatively.

FIG. 8-3-2 shows the diagram of ram engine/jet engine. Propeller(s) are alternatively added. Example choices of fuels are shown. Oxygen is sucked/emitted having vertical flow component Compressor is added to compress oxygen and/or fuels such as hydrogen, alternatively. It mixes up with hydrogen. It may have form of gas/liquid/solid/mist/plasma. With ignition/burning of fuels, it pushes the exhaust to out which causes propel/lift, force/motion. Formula might be used to calculate the how much reactions and energy release are necessary to lift/propel vehicle. One of formula may be

$$F ∝ Δ A \frac{{n}^{2}}{V} R \frac{Δ H}{Δ t} ,$$

alternatively.

FIG. 8-4 shows the diagram of space shuttle/space rancher/traveler.

FIG. 8-5 shows the diagram of engine of space shuttle/vehicle. It has fuels such as plasma fuel, nuclear fuel or chemical fuel. The combination such as oxygen and hydrogen is preferred They may have liquid or solid form preferably. The forms may be gas, liquid, solid, plasma, nuclear or mixed state, alternatively. The oxygen and hydrogen is exchanged from the fuel tanks. They mix up and ignite/fire. Amount control corks/gates are put. The sensing devices and control unit is added, alternatively. It tells to stop/reduce the amount to amount control such as corks and components or to choose optimal choices if there are any problems. The heat insulator and strong/flexible body may be used, alternatively.

FIG. 8-6 shows the diagram of engine. The mixing of hydrogen and oxygen is shown as preferred choice. If massive fuel such as chemical, plasma nuclear fuel is used, the expansion rate may be calculated with E=mc²,

$$Δ Q ∝ {( \frac{Rf}{Ri} )}^{γ}$$

where E is energy, m is mass, c is light speed, Q is energy, Rf is final radius, Ri is initial radius, γ is constant/variable. (γ=3 is usual value.) This formula may be true for explosion of fuel as well. This formula E=mc² includes the (informational) vibration as well

FIG. 8-7 shows the diagram of engine. The mixed stage or processing stage may be shown.

FIG. 8-8-1 shows the diagram of engine. Vertical motion is shown. Body weight shift may be used for controlling of direction, alternatively.

FIG. 8-8-2 shows the dram of engine. Vertical motion may be controlled by gas emission power of Left, Right, or plurality of units. They may be inter-connected to balance fuels, alternatively.

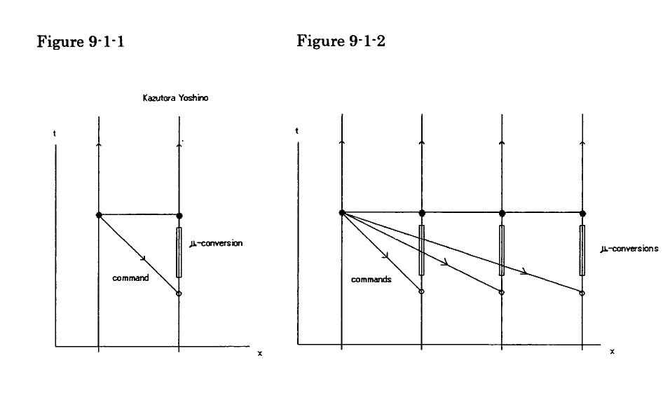

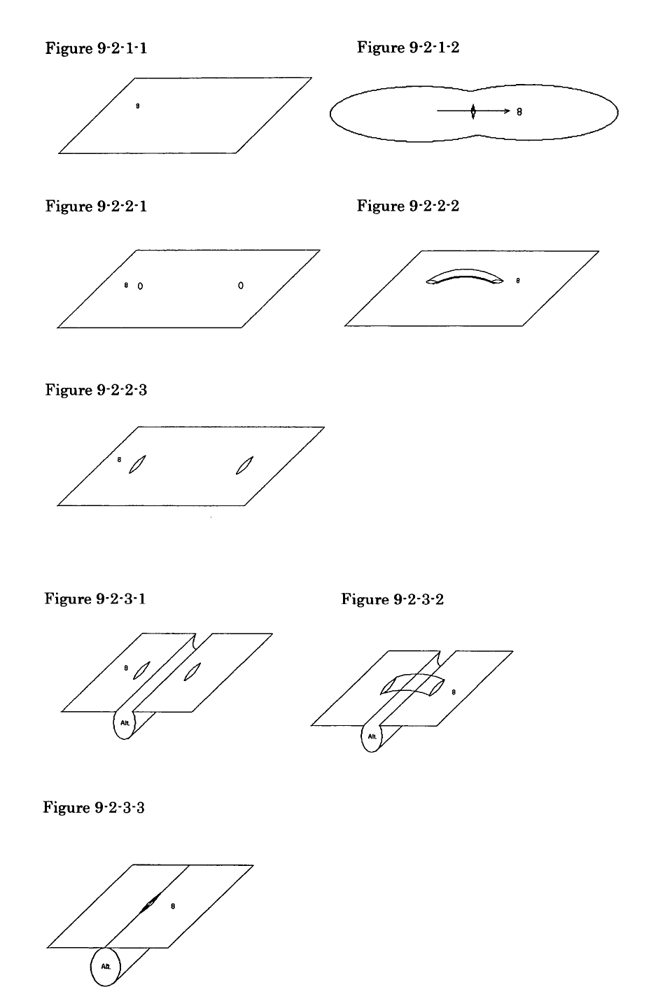

FIG. 8-9 shows the diagram of lam engine. Compressed oxygen is mixed up with hydrogen. It fires for force.

FIG. 8-10-1 shows the diagram of yoshino floater side view. It floats and runs.

FIG. 8-10-2 shows the diagram of floater bottom view.

FIG. 8-10-3 shows the diagram of yoshino floater perspective view. Head chooses the direction of motion. Head may rotate. It may have artificial intelligence for control. User may ride on it

FIG. 8-10-4 shows the diagram of basic structure of floater. It has air-inlet from which air comes in and air-outlet from which air come out. Fan(s) may be added to increase the lift, alternatively. The superconductor motor/superconductor ring motor may be used, alternatively. The ecology system with superconductor magnet (motor and/or generator) may be used, alternatively. Cooling system may be embedded, alaternatively.

FIG. 8-10-5-1 shows the diagram of floater leg. It may have ram engine in leg. Leg may be used for cooling system of superconductor magnet or motor.

FIG. 8-10-5-1 shows the diagram of floater leg. It may have ram engine/jet engine in leg. Fans are added, alternatively. Leg may be used for cooling system of superconductor magnet or motor.

FIG. 8-11-1 shows the diagram of space traveler. It has plasma engine with directional control. The control unit of magnetic field is added to control the flow of plasma. It may control the in-flow and/or outflow. The plasma engine has plasma having current with interaction with magnet, which control the plasma flow, which become force. It may be calculated by plasma equations. It shoots out plasma/ion/electron flux based on the current plasma has in magnetic field and/or electric field. Current runs between the core and surrounding electrodes. Plasma is between core and surrounding electrodes. Magnetic flux is vertical to current. Or magnetic field is parallel to electrodes. Alternatively, electric field is put vertical to direction of current

$${F}^{->} = q ( {E}^{->} + {v}^{->} \times {B}^{->} ) and / or \int ρ \frac{ⅆ u}{ⅆ t} ⅆ V = F$$

may be used for calculation. F is force, q is charge, E is electric field v is velocity, B is magnetic field. ρ is density, u is velocity, t is time, V is space(-time) volume, F is force. Controlling flow and direction of plasma out-flow is done by controlling field such as magnetic and/or electric field. Alternatively, the plasma sheet is scattered from space traveler. Alternatively, it captures plasma and used for force. It may be used for the (traveling/propelling/lifting) force using space flow of particles. In that case, the directional flow control may be set to opposite direction of plasma sheet/plasma engine, alternatively.

FIG. 8-11-2 shows the diagram of plasma engine with direction control. Magnetic field and/or electric field is changed for directional control or for balance. Two magnetic and/or electric fields/fluxes have opposite direction to bend plasma flow direction. The field does not have to be opposite. The amplitudes may be controlled. It causes the system to move in the different direction. Based on the vector/tensor field controlled how much the fluxes/flows of plasma/ion/electron bent are controlled. So this is space ship.

FIG. 8-11-3 shows the diagram of space ship type Q. It has container/insulator. It may control temperature of space ship. It has optimal control units.

FIG. 8-11-4 shows the diagram of space ship type QA. It has container/insulator. It may control temperature of space ship. It has optimal control units. It is showing when the field is not opposite. Separation unit is added for smooth flow, alternatively.

FIG. 8-12-1 shows the diagram of basics of Yoshino flying object (Y.F.O.) engine. It has energy/particle emitter and/or receiver. It has directional controls with fields such as electric field and/or magnetic field. Energy reactor is included. Specially mixed chemical, plasma, nuclear elements are used, alternatively.

FIG. 8-12-2 shows the diagram of Y.F.O. side view. There are energy reactor in the center and ducts connecting to the center. Energy reactor may be made of nuclear reactor with magnetic field

FIG. 8-12-3 shows the diagram of Y.F.O. This type has fuel box with ducts for air/gas/liquid/solid plasma flow, with flow channels and its control. The flow may be from top to bottom, from bottom to top, from side to side, from side to bottom, from side to top, from bottom to side, or from top to side. Controls/corks/gates are added to control the flow, alternatively.

FIG. 8-12-4 shows the diagram of multi-environmental space-ship. It has super conductor coating surrounding the system. Gradient of magnetic field VB helps it to lift/float. Type I, Type II and/or Type III (combinations) may be used. Cooling system may be included, alternatively. Components of ecology system may be included, alternatively. Yoshino system intelligence may be included, alternatively. It may be able to view the future, alternatively with yoshino time machine.

Yoshino multi-environmental ship is communicating/traveling in KAZUTORA-YOSHINO-LIGHT-OMNI-VICTORIOUS-ENCOURAGE-ASTRONOMICA-LOGICA-IMA-SPACA-ECONOMICA, KAZUTORA-YOSHIN-LOVE-ALIS-E, in YOSHINO UNIVERSE. Super conductors are included/used.

FIG. 9-1-1 shows the diagram of instant travel/fax/copier. Whenever-gate and/or where-door are shown. It send the information to past. It produces the same as original in different time-space-informational coordinates. Conversion from other source may be allowed, alternatively. If original is not human/animals, the original could be destroyed so that, it is virtually equivalent to instant travel.

FIG. 9-1-2 shows the diagram of instant travel/fax/copier. Multiple whenever-gate and/or where-door are shown. It or they send the information to pasts. It may be to the same time or to the different time(s). It may be to the same location or to the different location(s). It may be to the same object or to the different object(s). It produces the same as original or similar to the original in time-space-informational coordinates. If original is not human/animals, the original could be destroyed so that, it is virtually equivalent to instant travel/fax/copy.

FIG. from 9-2-1-1 to FIG. 9-2-3-3 show the diagrams of instant travel having control of space-time-informational coordinates.

FIG. 9-2-1-1 shows the diagram of the diagram of element (including object(s)) at space-time-informational coordinate.

FIG. 9-2-1-2 shows the diagram of element with space-time-informational coordinate. It Coordinates are shrinking and/or expanding properly so that traveling element may travel through faster than usual.

FIG. 9-2-2-1 shows the diagram of element with space-time-informational coordinate. It shows coordinates with warm holes.

FIG. 9-2-2-2 shows the diagram of element with space-time-informational coordinate. It shows the rainbow bridge.

FIG. 9-2-2-3 shows the diagram of element with space-time-informational coordinate. It shows cut(s)/hole(s) in coordinates.

FIG. 9-2-3-1 shows the diagram of element with space-time-informational coordinate. It shows cut(s)/hole(s) and fold(s) of coordinates.

FIG. 9-2-3-2 shows the diagram of element with space-time-informational coordinate. It shows cut(s)/hole(s), fold(s), and bridge(s) of coordinates.

FIG. 9-2-3-3 shows the diagram of element with space-time-informational coordinate. It shows cut(s) and/or fold(s)

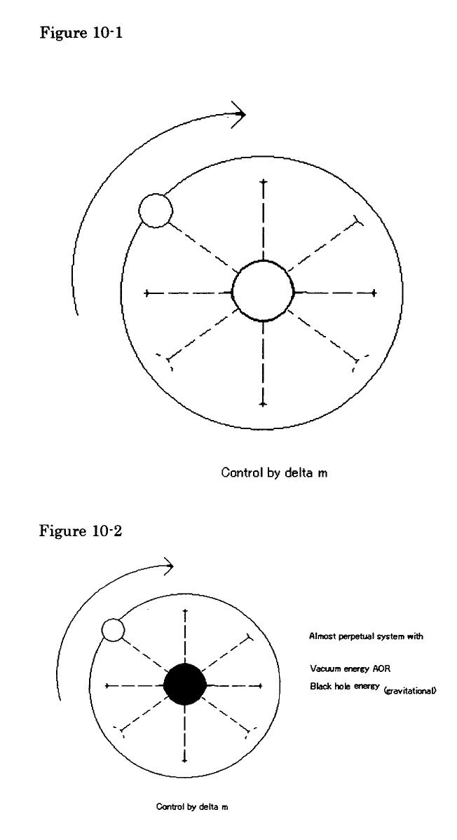

FIG. 10-1 shows the diagram of almost perpetual system. When ecology system motion unit is moving/rotating, and if the delta mass is controlled so that entire mass is virtually the same, entire momentum is conserved. Only the delta m momentum is modified in almost perpetual system. If the delta mass unit/base system has charger to save momentum/energy, it keeps reusing the momentum and energy.

FIG. 10-2 shows the diagram of almost perpetual system. Gravity and/or black hole are used for motion generation and/or control of element(s)/object(s).

1. In an ecology system, said system comprising group comprising
confiner means comprising group comprising container, insulator, wall, ceiling, floor, boundary maker, material, control system means comprising group comprising energy, entropy, field, particles, potential, kinetic energy, heat, vibration, information, time, space,
energy supply means supplying energy to energy converter and transfer means,
storing energy means that separate or electrolyze original component means to separated components means using said energy converted and transferred by said energy converter and transfer means,
emitting energy means and said storing energy means in which energy can be exchanged with or without energy charger & releaser means,
said energy charger and releaser means in which energy from said energy converter and transfer means is charged and released, in which energy from said emitting energy means and said storing energy means is charged and released,
components containers, heat pipes, pipes, energy transferring lines,
alternatively, pressure heat managing system means, cooling system, and
Alternatively, yoshino system, yoshino time machine,

2. The ecology system defined in claim 1, wherein said energy supply means is composed of the group of combinations comprising
solar energy, wind energy, heat energy, electrical energy, nuclear energy, and external electricity supply.

3. The ecology system defined in claim 1, wherein said energy converter and transfer means is composed of the group of combinations comprising
Energy converter of solar energy to electrical energy, solar panels, solar thermal electricity generator, solar unit with multi-layer boundary,
Energy converter of wind energy to motion to electricity, wind fan electricity generator,
Energy converter of heat energy to electricity, heater of water, heater of said chemical components, piezo element and
Energy converter of motion to electricity, electricity generator, electromagnetic electricity generator, and motor.

4. The ecology system defined in claim 1, wherein said storing energy means is composed of group comprising
Particles separating system, electrolysis system comprising
Electrode means comprising the group of combinations comprising inorganic components such as platinum, metals, and organic components, and
Components separating chambers that electrolyze said original components means to generate said separated chemical component means, and
alternatively, heating system of said original components.

5. The ecology system defined in claim 1, wherein said emitting energy means is composed of the group of combinations comprising
Fuel cell means comprising group comprising fuel cell,
Proton exchange membrane fuel Cell,
Alkaline fuel cell
Phosphoric-acid fuel cell,
Solid oxide fuel cell
Molten carbonate fuel cell, and
Hydrogen-oxygen fuel cell.
Fuel means comprising group comprising
Gas, liquid, solid, plasma, particle, super string, chemical, hydrogen, oxygen, metal-hydrate, carbon-hydrate, alcohol, inorganic material, organic material,
Super conductor,
Super conductor magnet,
Superconductor motor means, comprising group comprising, superconductor motor, motor, generator, electrical motor, superconductor magnet, type one super conductor magnet, type two super conductor magnet, type three superconductor magnet, cooling system, chemicals, coolant, hydrogen, oxygen, nitrogen, electricity, and magnet,
Superconductor generator means, comprising group comprising, superconductor generator, generator, motor, ring superconductor motor, super sound motor, super sound super conductor motor, superconductor magnet, electricity generator, type one super conductor magnet, type two super conductor magnet, type three semiconductor magnet, cooling system, chemicals, coolant hydrogen, oxygen, nitrogen, electricity, and magnet,
System energy controlling unit means comprising group comprising switch, transistor, integrated circuit, capacitor, coil, computer, battery, storing energy unit, fuel cells, energy supplying units,
Heat managing system means to control the temperature or heat of components comprising group comprising said superconductor motor, said superconductor generator means, said system energy controlling unit means, said fuel cell means, heat managing system to carry the heat from engine or motor.
Alternatively, hydrogen engine means comprising group comprising hydrogen engine, turbo hydrogen engine, hydrogen jet engine, turbo hydrogen jet engine, nuclear fission engine, nuclear fusion engine, plasma engine, hydrogen and oxygen engine, hydrogen and oxygen engine with fuel exchanger, fuel mixer, fuel controller, character sensor, ram engine, and hydrogen ram engine,

6. The ecology system defined in claim 1, wherein said energy charger and releaser means is composed of the group of combinations comprising
Battery, chemical battery, secondary battery, dry cell battery, mercury battery, lead storage battery, nickel cadmium battery, fuel cells, aluminum air battery, superconductor energy charger and releaser, and electromagnetic energy charger and releaser.

7. The ecology system defined in claim 1, wherein said original component means is composed of the group of combinations comprising
Water, chemical components that can be electrolyzed, organic chemical components, ethanol, ethyl alcohol, methyl alcohol, heptanes, acids to increase the amount of ions of original chemical components such as hydrochloride acid, nitric acid, perchloride acid, sulfuric acid, and
Helium, resultant components of nuclear fusion.

8. The ecology system defined in claim 1, wherein said separated components means is composed of the group of combinations comprising
Hydrogen, oxygen, chemical components that is results of electrolysis of said original components, protons, deuterium, tritium, and helium.

9. The ecology system defined in claim 1, wherein said pressure and heat managing system means is composed of the group of combinations comprising
Pipes, heat pipes, piezo, heat-electricity converter, piezo-heat-electricity converter, coolant such as water, hydrogen-oxygen and water separating filter, hydrogen-oxygen and water separting chamber, and
compressor that compress said separated component means

10. In yoshino time machine system, box type yoshino time machine comprising group comprising
Element means comprising group comprising superstring, elementary particle, particle, atom, molecule, chemical, physical matter, matter, wave, sound, vibration, field, potential, temperature, energy, momentum, spin, beam, nano-element, carbon-hydrate, benzene-chemical, carbon sixty, and carbon seventy,
Element container, to have proper behavior of said element means,
Element emitter means comprising group comprising
Emit unit, laser, red ray laser, green ray laser, blue ray laser, infrared laser, ultraviolet laser, electron laser, positron laser, beam, particle, laser, energy beam, and energy laser,
Element receiver means comprising group comprising
Mirror, sense unit, reflector, laser, red ray laser, green ray laser, blue ray laser, infrared laser, ultraviolet laser, electron laser, positron laser, beam, particle, laser, energy beam, and energy laser,
Element behavior monitoring means comprising group comprising
Sensor to measure character of element,
Sensor to measure chats of element in different time and location,
Sensor to measure characters of plurality of elements,
Element analyzing means comprising group comprising
Computer, database, and combination-probability information handler.
Memory means comprising group comprising
Memory, hard drive, recording device, comparing device, verifier, and wafer,
Input information system,
Converting information system, and
Output information system,

11. Plasma jet engine comprising group comprising
a. particle means,
b. current generator means,
c. field generator means,
d. plasma flux controller means,
e. controller means
f. material means, and
g. yoshino system.

12. In the claim of 11, wherein said particle means comprising group comprising
ion, electron, charged element, plasma, plasma sheet, plasma field, particle, particle fields, energy field, fuel,
elementary particle, super string, boson, fermions, atom, molecules, and chemical.

13. In the claim of 11, wherein said current generator means comprising group comprising
current generator, voltage maker, energy supply, solar panel, and fuel cell.

14. In the claim of 11, wherein said field generator means comprising group comprising
magnetic field, electric field, electromagnetic field, energy field, momentum field, plasma field, vector field, tensor field, and plasma sheet.

15. In the claim of 11, wherein said plasma flux controller means comprising group comprising
electric field or potential generator and controller, magnetic field or potential generator and controller, electro-magnetic field or potential generator and controller, heat field or potential generator and controller, energy field or potential generator and controller, superconductor magnet, superconductor energy charger, superconductor wire, and superconductor field generator.

16. In the claim of 11, wherein said controller means comprising group comprising
computer, integrated circuit, battery, fuel cell, solar panel solar unit, wind energy capture, solar wind energy capture, solar wind holder, solar wind shield, cooling system, and temperature controlling system.

17. In the claim of 11, wherein material means comprising group comprising
material, superconductor, insulator, heat insulator, body material, body element, electrodes, container, shield, plasma shields, and plasma sheet,

18. Ion cooling system comprising group comprising
particle means comprising group comprising ion, ion gas, ion liquid, plasma, gas, liquid, and solid,
potential maker means comprising group comprising
voltage maker, electrode, electrodes, ground, magnet, magnetic field maker, electric field maker, energy supply, potential supply, gravity field maker, and maker,
compressor means comprising group comprising
compressor, fan, energy supply, pressure supply, and compression maker,
laser means comprising group comprising
laser, red ray laser, green ray laser, blue ray laser, infrared laser, ultraviolet laser, electron laser, positron laser, beam, particle, laser, energy beam, and energy laser,
energy supply means comprising group comprising
energy supply, solar panel solar wind energy receiver, wind energy receiver, fuel cell,
container means comprising group comprising
body, insulator, plasma shield, plasma sheath, material, rigid body, soft body, and mixed body,
material means comprising group comprising
body, insulator, plasma shield, plasma sheath, material, rigid body, soft body, mixed body, and said particle means.

19. Instant traveling or copying system having yoshino time machine system.

20. In the claim of 1, 10, 11, 18, 19, wherein plurality of said system.

21. Process to make product comprising group comprising sheet material, product, metal plastic, glass, organic material, inorganic material, fuel, plasma, liquid, solid, and gas, vehicle, food, information, data computer, having combinations of group processes of copying, sending, printing, transporting, summing, putting, lining, cutting, melting, laser cutting, plasma cutting, shaping, folding, attaching, moving, whenever moving, wherever moting, conveying, shifting, roting, bending, shearing, extending, condensing, melting, spraying, pealing, coating, plasma-coating, adding, subtracting, multiplying, dividing, assembling, attaching, polishing, painting, holding, exhaling, cleaning, analyzing, packaging, taping, checking, and containing.

22. In the claim of 21, wherein said process comprising group process, getting order, getting order through internet, getting order from future, getting order from past, getting order from present, making massive amount, copying, designing for customer, modifying design, modifying process, importing, getting materials on line, assembling bottom portion of vehicle, letting vehicle move through the line, robot arm assembling, shifting product, folding proper sections, attaching gaps, melting gaps, adding connecting element to gap, polishing connecting element, sensor checking, showing signs, analyzing, attaching more parts, typing, taping, doing repetitive processes, painting, packaging, containing, exporting, receiving money, checking customer satisfactions, feeding back, feeding forward, and combining reactions to products.
